(19) United States
(12) Patent Application Publication
(10) Pub. No.: US 2010/0223340 A1
(43) Pub. Date: Sep. 2, 2010

(54) SYSTEM FOR REMOTELY SCANNING A DOCUMENT

(76) Inventors: Rob Pope, Castle Rock, CO (US); George Giangeruso, Pine Brook, NJ (US); Kazutaka Oba, Johns Creek, GA (US); Tomoki Hattori, Tucker, GA (US)

Correspondence Address: OBLON, SPIVAK, MCCLELLAND MAIER & NEUSTADT, L.L.P., 1940 DUKE STREET, ALEXANDRIA, VA, 22314, US

(21) Appl. No.: 12/394,121

(22) Filed: Feb. 27, 2009

(51) Int. Cl. G06F 15/16

(52) U.S. Cl. 709/206

(57) ABSTRACT

A method and system for acquiring an image and transmitting the image from an image processing apparatus to a computing device. The method includes executing an application program by the computing device; indicating, using the application program, that an image is to be acquired using the application program; transmitting an XML message from the computing device to the image processing apparatus over a computer network using HTTP, the XML message indicating that the image is to be acquired; receiving the XML message by a web service application executing on the image processing apparatus; translating the XML message into at least one command compatible with a scanning application of the image processing apparatus; acquiring the image by the scanning application of the image processing apparatus using the at least one command; transmitting the image over the computer network from the image processing apparatus to the computing device; and storing the image on a storage medium of the computing device.

### BACKGROUND OF THE INVENTION

1. Field of the Invention

This invention relates to a scanning system that transfers an image from a scanner over a network to a client computer. The invention is more particularly related to a system that allows a client computer to control a scanner connected to a network and to receive images from the scanner over the network in a manner that emulates a direct connection of the scanner to the client computer.

2. Discussion of the Background

Image scanners are becoming a more popular device in office environments both for enabling images to be included in documents and also to obtain images of documents in order to perform optical character recognition. Many people who use image scanners on an infrequent basis do not have the luxury of being able to directly scan an image into an application program running on their own computer. In the situation where the user does not have a scanner, the user must go to a scanner and generate a file containing the image. This image file can then be copied to a floppy disk and walked to the user's computer. The user's computer then reads this disk in order to process the image file.

U.S. Pat. No. 5,911,044 is directed to a system and method for performing scanning operations using a scanner connected to a server computer and transmitting acquired images from the scanner server to a client computer. A scan-to-application process is utilized that allows control of the scanner or other image acquiring device which is connected to a scanner server using a virtual TWAIN driver, which interfaces to an application program running in the client computer. Image files are also transmitted to a local file storage device of the client computer using a scan-to-file operation. A network protocol is used to implement both the scan-to-application and scan-to-file operation. Computer memories are utilized to store data structures or tables containing various information utilized during the file transfer procedures. Computer memories are also used to buffer and store the protocol packet headers and transmitted information.

TWAIN is a standardized software protocol that provides a universal standard for communication between applications and image acquisition devices like scanners and digital cameras. TWAIN is fully described in the TWAIN Specification, Version 1.9a, which is incorporated herein by reference.

FIG. 1 illustrates the software components of a conventional TWAIN application running on a workstation 20 (e.g., a computer) connected to a scanner 50. As illustrated in FIG. 1, the workstation 20 contains three major software components; an application program or software 22, a source manager 32, and a source device driver 42. The application software 22 includes any type of application program which inputs or acquires images from a scanner or other image acquiring device. The application software 22 includes a pull-down menu 24 which includes various options including an option to acquire an image (e.g., scan an image), and an option to select a source of the images. The application software 22 is written by the application software developer in order to be compatible with the TWAIN standard. The TWAIN standard defines a standard software protocol and API (application programming interface) for communication between software applications and image acquisition devices (the source of the image data).

A source manager 32 is software that manages the interactions between the application and the source of images. The source manager software is software code which is provided in the readily available TWAIN Developer's Toolkit and allows the management or selection of different sources of images. The source manager 32 includes software that provides a menu 34 which allows the user to select a source of images. The source software or source device driver 42 is software which controls the image acquisition device and is written by the device developer to comply with TWAIN specifications. The source device driver 42 includes a source user interface 44 that allows control of the scanner 50 including the control of the parameters of the scanner 50. The source device driver 42 is usually written by the manufacturer of the scanner 50. The source device driver 42 may be installed in a manner which is analogous to installing a print driver in a windows-based computer. Further information about TWAIN is disclosed in the TWAIN Specification, Version 1.9a.

FIG. 2 illustrates a client computer 102, a scanner server computer 130, and a file server computer 122, each connected by a computer network 120. The scanner server computer 130 is connected to a scanner 144 via a bus or cable 140. Preferably, the bus 140 is a SCSI (Small Computer System Interface) bus or cable, although any suitable communication line, device, or method may be used to communicate between the scanner 144 and scanner server computer 130. Also connected to the network is a file server 122 which can be any type of computer that stores files. However, it is to be noted that the file server is not needed to perform the transfer of images from the scanner server computer 130 to the client computer 102. Each of the elements illustrated in FIG. 2 are connected by a network 120. Therefore, the client computer 102 and the scanner server 130 include network interfaces such as network interface cards.

This network 120 may be implemented as any type of network such as a Novell network or local area network (LAN) in which the computers utilize NetWare by Novell as a network operating system using the SPX/IPX (Sequence Packet Exchange/Internetwork Packet Exchange), a Microsoft based network configured for SPX/IPX or TCP/IP, or may be implemented using the TCP/IP (Transmission Control Protocol/Internet Protocol) which is a popular networking protocol for use on the Internet and also for most UNIX implementations.

A wide area network (WAN) may also be used. Further, other networks such as a network used with Apple Computers, such as the Apple Talk network, or any other type of network including the Internet may be utilized. When a WAN or the Internet is utilized, the client and/or scanner server computers may be first connected to a LAN.

A functional block diagram of the software and other components illustrated in FIG. 2 is set forth in FIG. 3. The client computer 102 includes an application program 104 such as a program that acquires images. The application program may also process the image data that is acquired. The application program 104 is any commercially available application program that acquires images, and is TWAIN compatible. Within the application program 104 is included source manager software (not illustrated) that is conventional in nature and has been described with respect to the source manager software 32 illustrated in FIG. 1. The application program software 104 communicates with the scanner server computer 130 utilizing a virtual TWAIN driver 106 that interfaces with the application program 104.

Dynamic Web TWAIN, developed by Dynamsoft, is a software product for installation in a client web browser that provides for the acquisition of images from any TWAIN-compatible device. Dynamic Web TWAIN supports the major compression methods, such as JPEG, TIFF, and PNG, and is compatible with FTP and HTTP. Further, Dynamic Web TWAIN supports all major web browsers, such as Internet Explorer, Mozilla, and Firefox. However, Dynamic Web TWAIN requires a TWAIN device driver in the client PC to scan the image from the source. The web interface merely provides the user with access to the scanning device through the client PC's TWAIN device driver.

FIG. 4 illustrates a conventional system for performing scanning operations over a network. A client computer 401 includes a virtual TWAIN driver that interfaces with one or more applications on the client computer. Command and parameters related to the scanning operation are communicated over the network using a network protocol to the scanning device 402, which includes a TWAIN interface. Scanned images are transmitted over the network and stored on the client computer 401. However, this system can suffer from slow scanning performance due to high data volume on the network. Further, due to a maximum buffer size, a scanned document may be transmitted one page at a time, resulting in further delays.

### SUMMARY OF THE INVENTION

Accordingly, it is an object of this invention to provide a network scanning system which allows the transfer of image information from a scanner to a client computer using HTTP/XML.

According to one embodiment of the invention, there is provided a method of acquiring an image and transmitting the image from an image processing apparatus to a computing device, comprising the steps of: (1) executing an application program by the computing device; (2) indicating, using the application program, that an image is to be acquired using the application program; (3) transmitting an XML message from the computing device to the image processing apparatus over a computer network using HTTP, the XML message indicating that the image is to be acquired; (4) receiving the XML message by a web service application executing on the image processing apparatus; (5) translating the XML message into at least one command compatible with a scanning application of the image processing apparatus; (6) acquiring the image by the scanning application of the image processing apparatus using the at least one command; (7) transmitting the image over the computer network from the image processing apparatus to the computing device; and (8) storing the image on a storage medium of the computing device.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 illustrates a conventional computer workstation connected to an image scanner, the workstation executing an application program which uses a TWAIN driver;

FIG. 2 illustrates a client computer, a scanner server which is connected to an image scanner, and a file server, each connected by a computer network;

FIG. 3 illustrates the software components and further details of the client and scanner server computers illustrated in FIG. 2;

FIG. 4 illustrates a conventional computer workstation connected to a multifunction (MFP) device (scanner/printer/copier) over a network, the workstation executing an application program that uses a TWAIN driver;

FIGS. 5A-5C illustrate a first embodiment in which a Java servlet application is resident on the MFP device;

FIG. 6 illustrates the TWAIN software elements;

FIG. 7 illustrates a state transition diagram for TWAIN;

FIGS. 8A and 8B illustrate a graphical user interface of a universal/mobile TWAIN driver;

FIG. 9 illustrates the emulation of an MFP scanning screen using HTML tags according to an embodiment of the invention; and

FIG. 10 illustrates a flowchart according to a method of scanning.

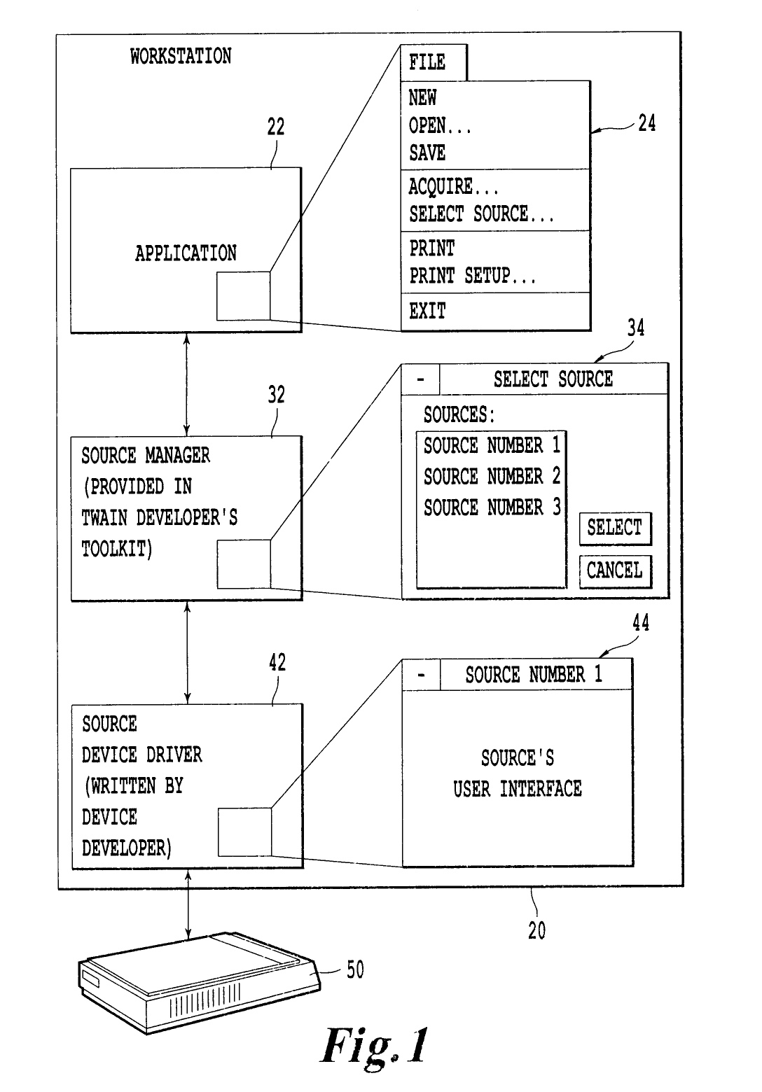

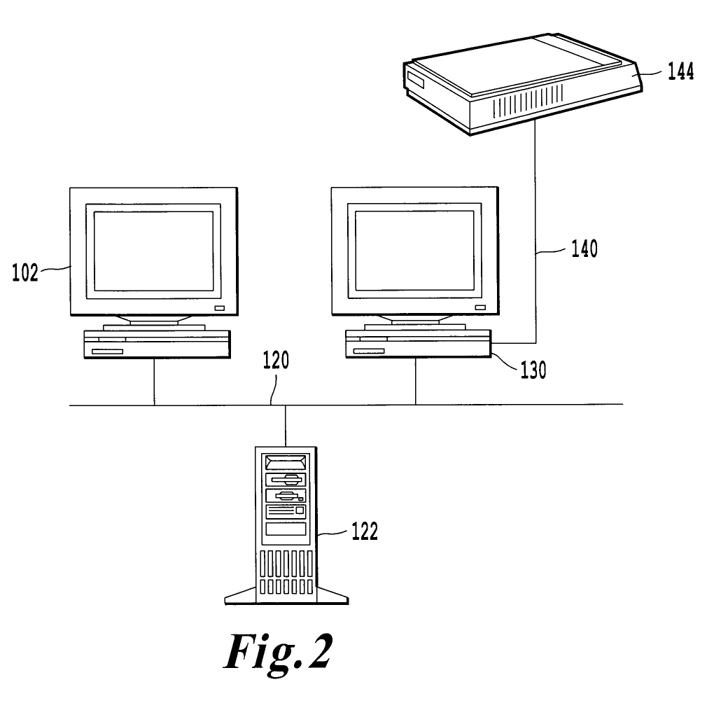

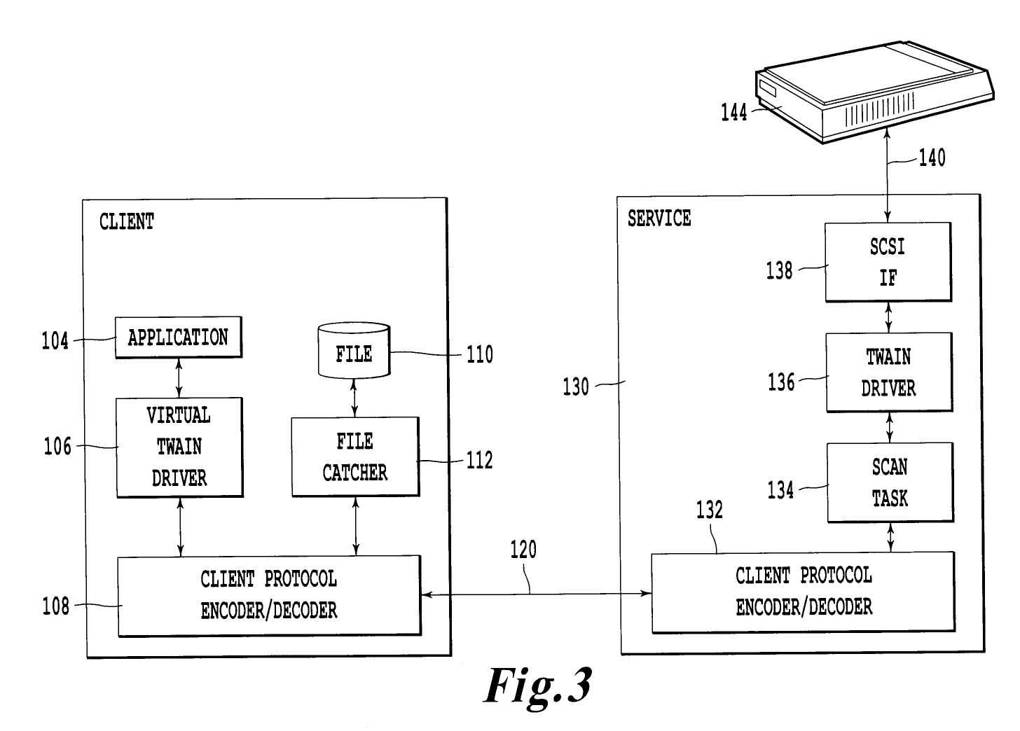

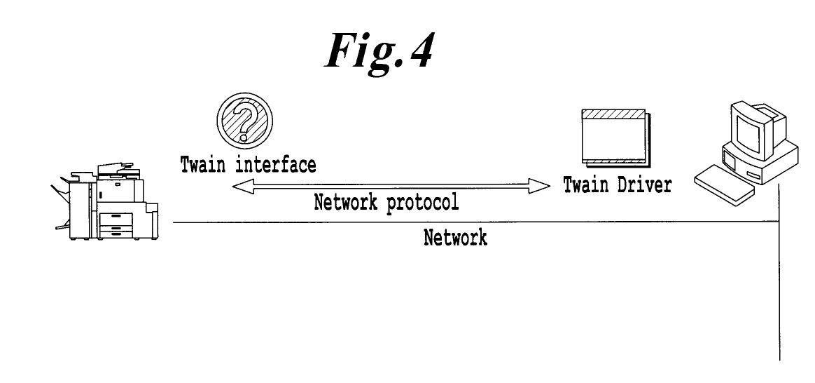

### DESCRIPTION OF THE PREFERRED EMBODIMENTS

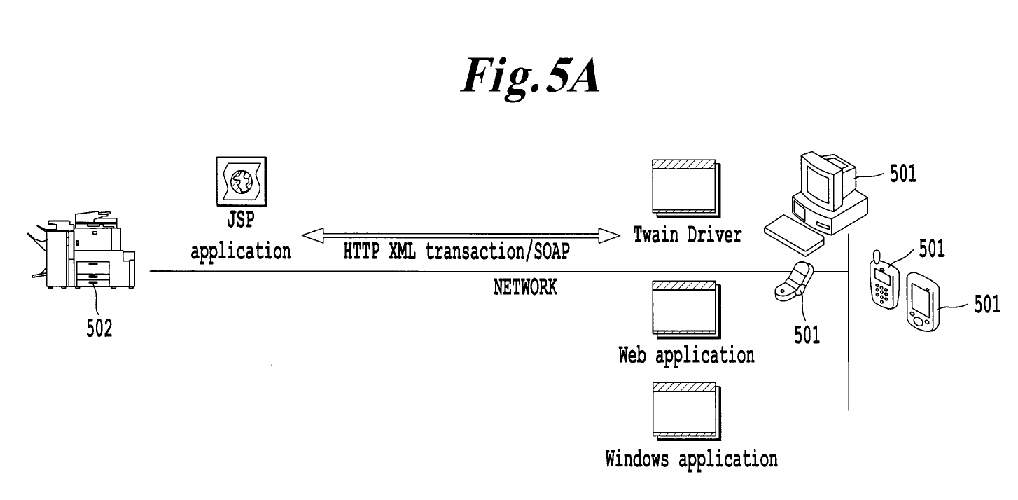

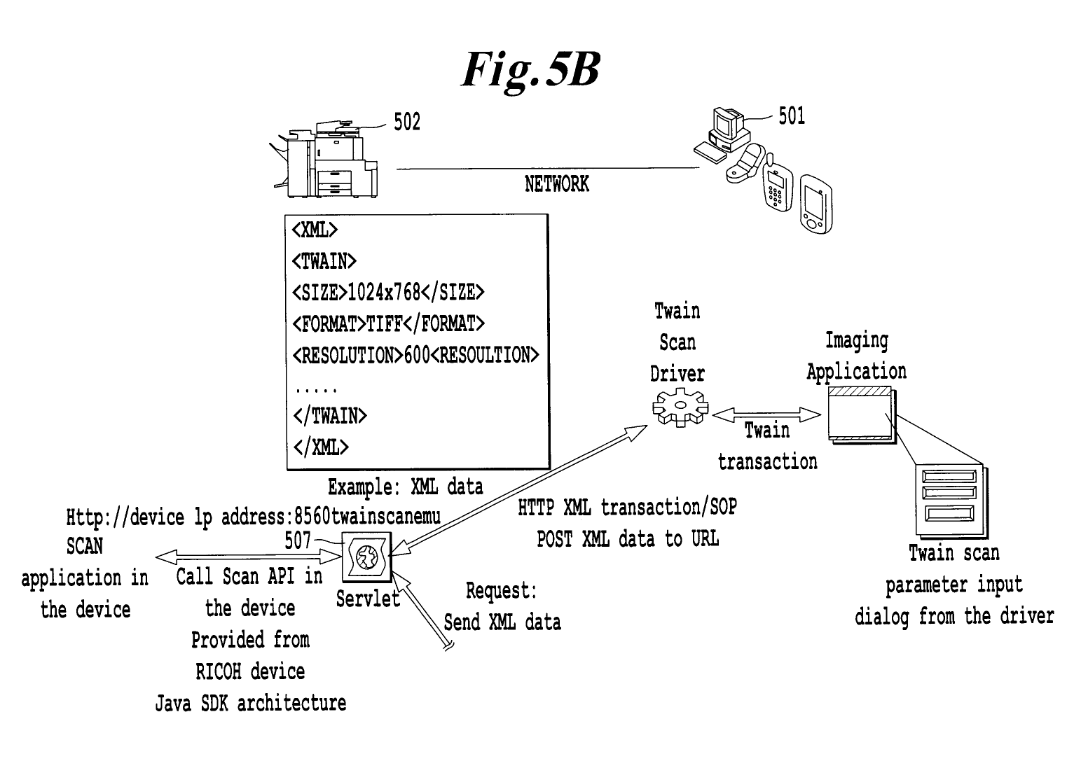

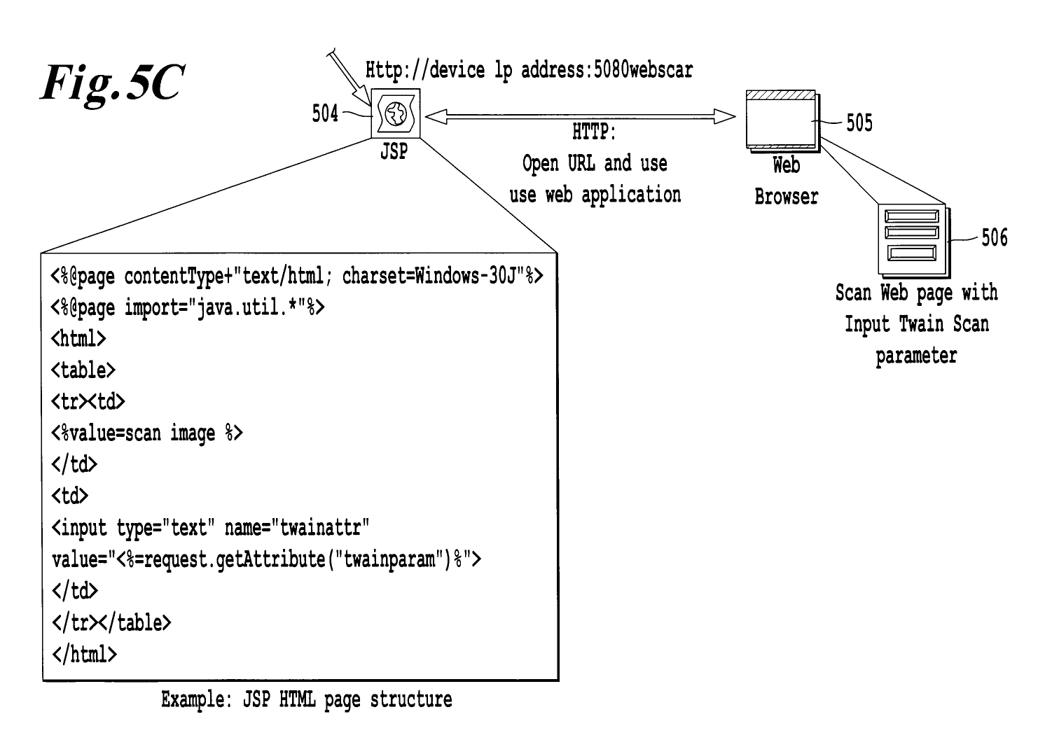

Referring now to the drawings, wherein like reference numerals designate identical or corresponding parts throughout the several views, and more particularly to FIG. 5A, there is illustrated a system according to an embodiment of the invention.

In particular, FIG. 5A illustrates a client device 501 and a MFP device 502 connected by a computer network 503. The client device 501 can be any type of computing device that can execute a web browser, such as a general purpose computer, a cell phone, a PDA, etc. The client device includes a web application, a word processing program, a Windows-based application, or other applications. Each client device includes a processor and a computer-readable medium such as RAM, ROM, and other storage devices.

The MFP device 502 includes web server functionality that can be implemented using a JavaServer Pages (JSP) application 504 and/or Java Servlet technology that provides an interface for network transactions between the MFP device 502 and any client application on the client device that communicates using, for example, XML messages. See “JavaServer Technology White Paper,” available at java.sun.com/products/jsp/whitepaper.html, which is incorporated herein by reference. The MFP device 502 and the client device communicate over the network 503 using the HTTP/HTTPS XML/SOAP protocol.

The Java servlet is, for example, a customized embedded application developed using Ricoh's Device SDK Type-J (SDK/J) state-of-the-art application development platform/environment. SDK/J is based on the Java ME technology and controls most aspects of device operation, including the control panel, and core capabilities such as printing, scanning, faxing and saving files. See “White Paper: Embedded Software Architecture SDK,” Version 1.0, June 2004, available at www.ricoh.com/esa/pdf/white_letter.pdf, which is incorporated herein by reference.

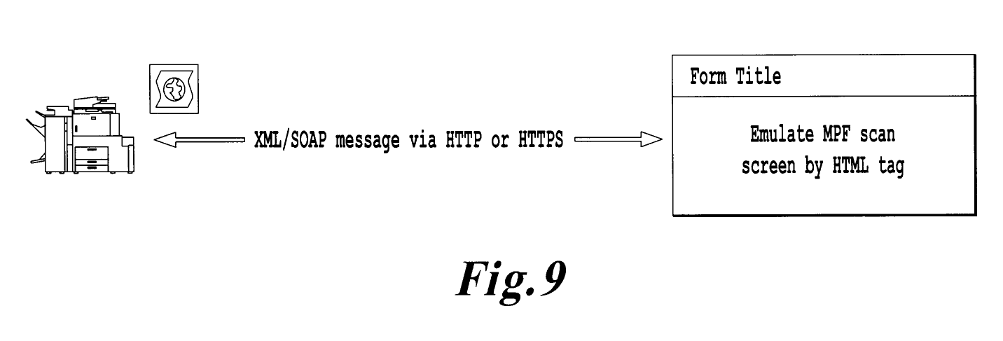

In this embodiment, the Java servlet is an application that can receive scan commands via HTML/XML. The Java application further translates HTML/XML scanner configuration messages into device SDK-compatible scanning settings, which can be used by a scanning application in the MFP device. See FIG. 9, which illustrates this process.

FIGS. 5B and 5C illustrate the system shown in FIG. 5A in greater detail. In particular, FIGS. 5B and 5C illustrate a “webscan” HTML file 504 that can be loaded in a web browser 505. In this way, the user can enter scanning parameters using the interface 506 shown in FIG. 5B. After the user enters the scanning information, an XML message representing a scanning request is handled by the Java servlet 507, which calls the scanning application of the multifunction device. After scanning, the scan data is sent from the scanning application to the web browser via HTTP.

FIGS. 5B and 5C also illustrates an alternative embodiment in which, instead of a web browser, an imaging application is used on the client side. In particular, in this embodiment, a user is able to enter scanning parameters corresponding to a scan request into an interface of the imaging application. A scan driver then posts XML data corresponding to the scan request to the URL corresponding to the servlet.

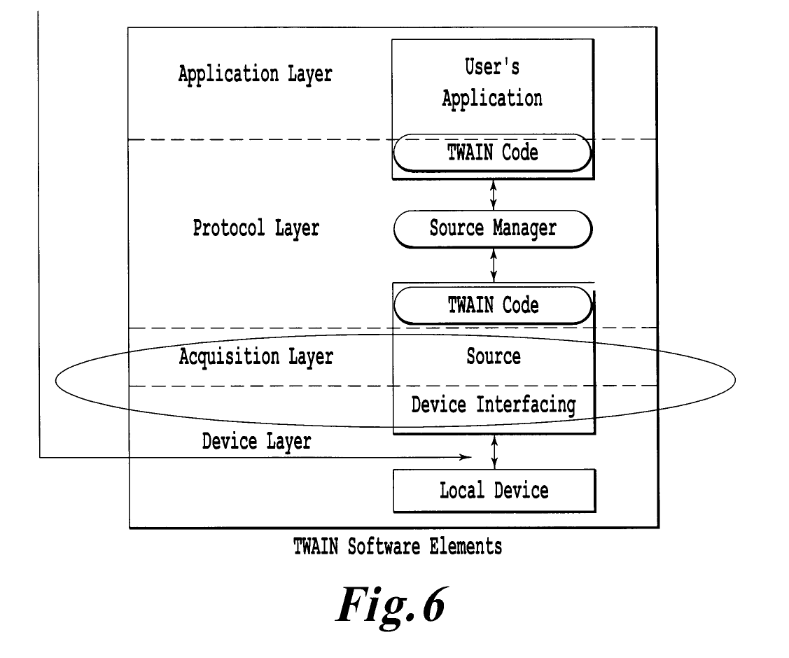

FIG. 6 illustrates TWAIN software elements. In an embodiment of the invention, the Java servlet 504 sets the device configuration and scan settings in the acquisition layer based on information received from the client via an XML message.

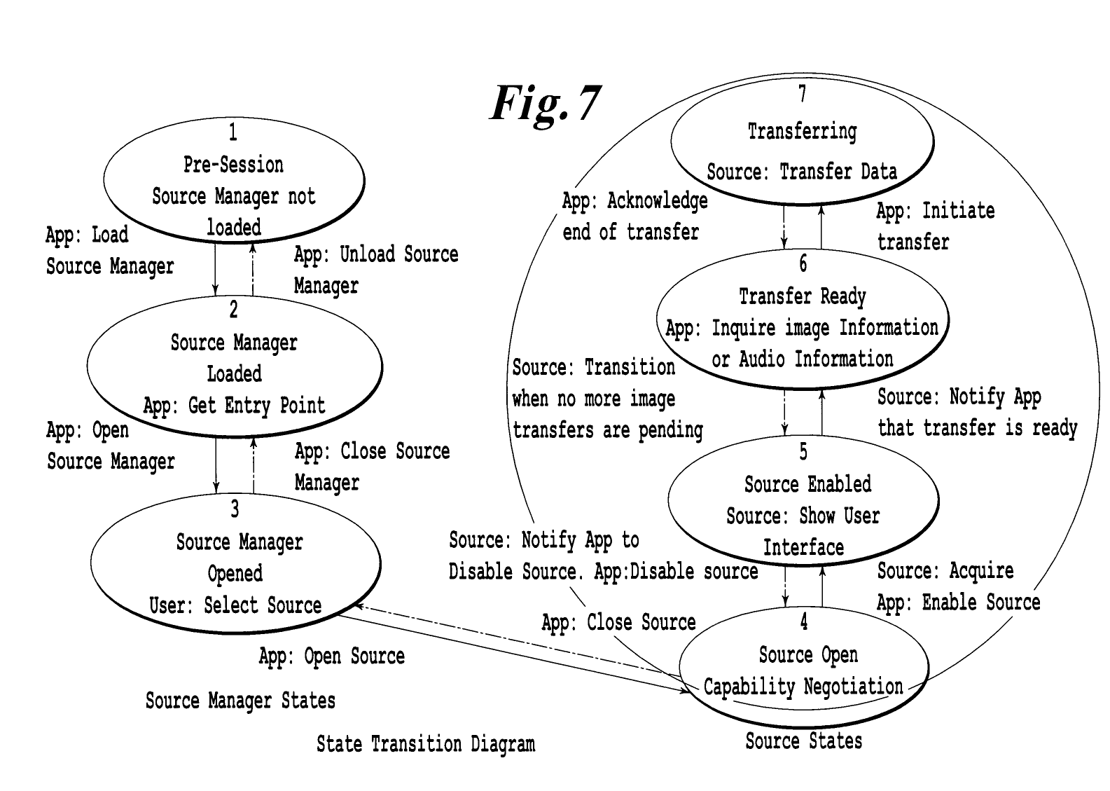

FIG. 7 illustrates a state transition diagram in the TWAIN protocol in which states 1-3 are occupied by the source manager, while states 4-7 are occupied by the source. In an embodiment of the present invention, the communication latency and the state transition latency at the source is minimized. In the flowchart, steps 4-7 are states in the communication between the application and TWAIN driver. The bottleneck in conventional TWAIN implementations occurs in state 7 in which the scan data is transferred. Scan data transferred from the device is done page-by-page when scanning multiple pages due to the device buffer size for TWAIN scanning. A method according to an embodiment of the present invention does not access the TWAIN I/F in the device, but uses a scan interface provided using Ricoh's Java SDK. This scan interface calls the scan service application in the device and saves scan data into a hard drive or memory assigned to the Java SDK in the device. After the scan is completed in this method, all scan data is ready to be transferred, and all the scan data is transferred at once.

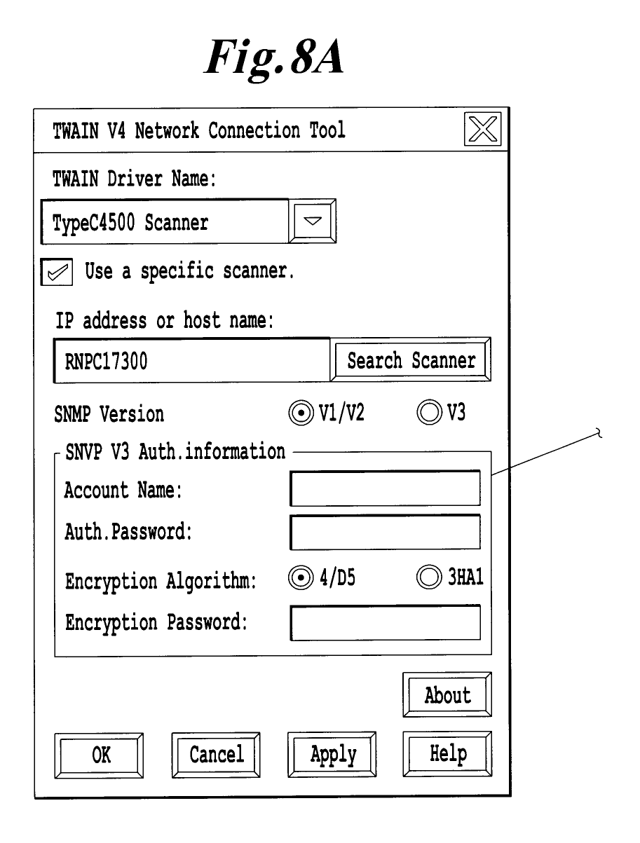

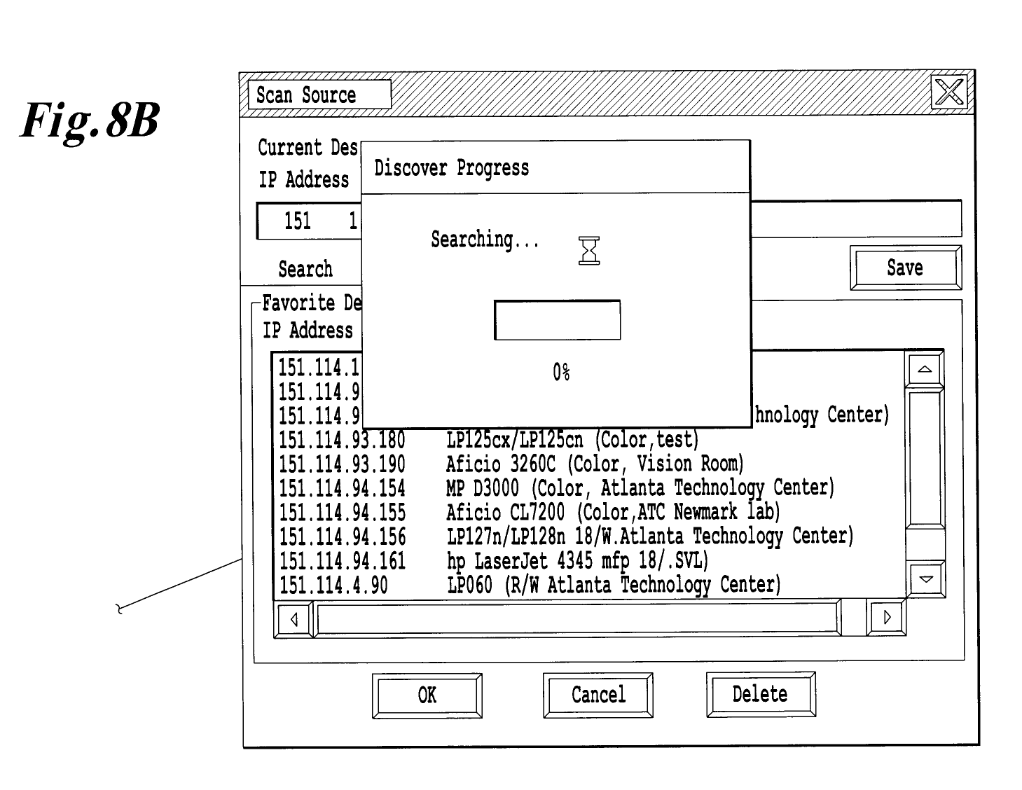

FIGS. 8A and 8B illustrate a user interface for a TWAIN network connection tool according to an embodiment of the present invention, wherein the user is able to specify the TWAIN driver name and an IP address of a specific scanner. The user is also able to specify which version of SNMP to use, as well as SNMP-related authentication information such as an account name and password. In response to the user's request, the connection tool searches for the scanner on the network.

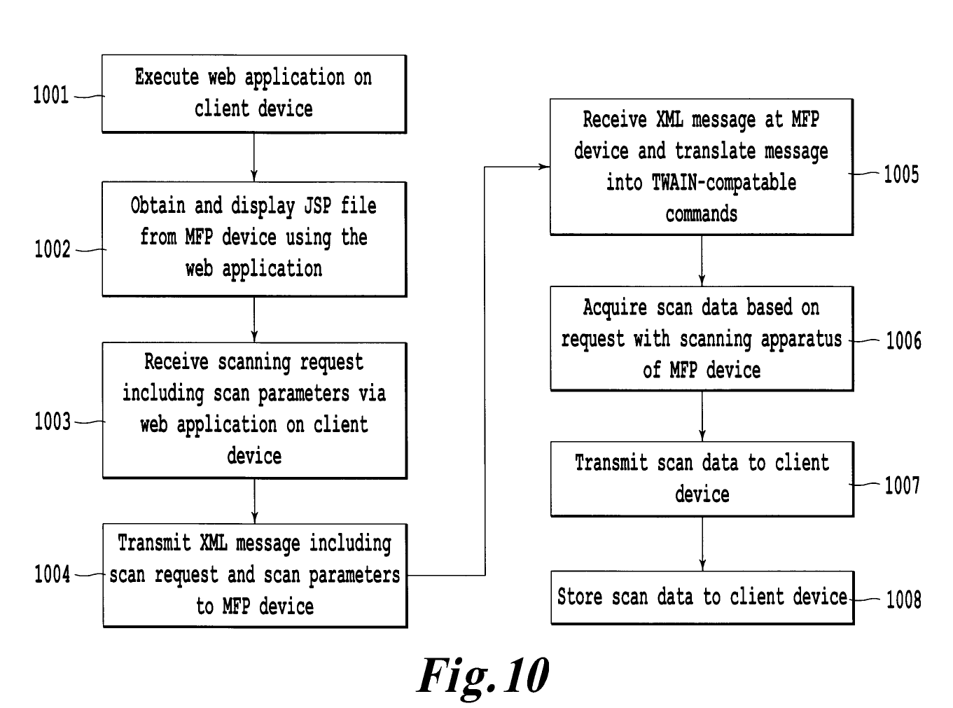

FIG. 10 illustrates a method of scanning according to the present invention. In step 1001, a client web application is executed on the client device 501. In step 1002, a scan driver, e.g., a TWAIN driver, is selected in the application. In step 1003, a user can enter a request for a scanning operation to be performed and enter parameters associated with the scan, including, e.g., resolution and format information. In step 1004, the scan parameters are converted to XML and the message is prepared and transmitted to the MFP device where it is handled by the Java servlet. In step 1005, the scan request in the XML message is translated into a format compatible with a scanning application of the MFP. In step 1006, the servlet communicates the request to the scan API in the device, and the image data is obtained by the scanning device associated with the MFP device. In step 1007, the scanned image data is transmitted to the client device via the TWAIN driver. In step 1008, the received scanning data is presented to the imaging application, for display or storage.

This invention may be conveniently implemented using conventional general purpose digital computers or microprocessors programmed according to the teachings of the present specification, as will be apparent to those skilled in the computer art. Appropriate software coding can readily be prepared by skilled programmers based on the teachings of the present disclosure, as will be apparent to those skilled in the software art. The invention may also be implemented by the preparation of application specific integrated circuits or by interconnecting an appropriate network of conventional component circuits, as will be readily apparent to those skilled in the art.

The present invention includes a computer program product which is a storage medium including instructions which can be used to program a computer to perform a process of the invention. The storage medium can include, but is not limited to, any type of disk including floppy disks, optical discs, CD-ROMs, and magneto-optical disks, ROMs, RAMs, EPROMs, EEPROMs, magnetic or optical cards, or any type of media suitable for storing electronic instructions. If desired, different storage mediums can be used to store the software used by the client computer and the scanner server. The present invention also includes memories which store the various data structures which include the tables and packet header structures used by the invention. The memories include, for example, RAMs including SRAMs and DRAMs, and disk memory such as a hard disk, and any other type of memories which are writable.

Numerous modifications and variations of the present invention are possible in light of the above teachings. It is therefore to be understood that within the scope of the appended claims, the invention may be practiced otherwise than as specifically described herein.

1. A method of acquiring an image and transmitting the image from an image processing apparatus to a computing device, comprising:
executing an application program by the computing device;
indicating, using the application program, that an image is to be acquired using the application program;
transmitting an XML message from the computing device to the image processing apparatus over a computer network using HTTP, the XML message indicating that the image is to be acquired;
receiving the XML message by a web service application executing on the image processing apparatus;
translating the XML message into at least one command compatible with a scanning application of the image processing apparatus;
acquiring the image by the scanning application of the image processing apparatus using the at least one command;
transmitting the image over the computer network from the image processing apparatus to the computing device; and
storing the image on a storage medium of the computing device.

2. The method of claim 1, wherein the application program is a web browser.

3. The method of claim 1, wherein the step of transmitting the XML message comprises transmitting the XML message using the SOAP protocol.

4. The method according to claim 1, further comprising the step of:
setting parameters of the acquiring step at the computing device.

5. The method according to claim 1, further comprising the step of:
determining, by the computing device, whether the image processing device is present on the network.

6. The method according to claim 1, further comprising the step of:
indicating, by a user at the image processing device, that the acquiring step is to be performed.

7. The method according to claim 1, wherein acquiring step comprises:
scanning the image.

8. The method of claim 1, wherein the step of transmitting the XML message comprises transmitting the XML message from the computing device to the image processing apparatus over the computer network using secure HTTP.

9. A system for acquiring an image, comprising:
a computing device, including
a processor configured to execute an application program that receives a request for an image to be acquired; and
means for transmitting an XML message from the computing device to the image processing apparatus over a computer network using HTTP, the XML message indicating that the image is to be acquired; and
an image processing device, including
a processor configured to execute a web service application that receives the XML message and translates the XML message into at least one command compatible with a scanning application of the image processing apparatus;
means for acquiring the image by the scanning application using the at least one command; and
means for transmitting the image over the computer network to the computing device.

10. The system of claim 9, wherein the processor of the computing device is configured to execute a web browser as the application program, wherein the web browser is configured to display a web page obtained from the image processing device.

11. The system of claim 9, wherein the means for transmitting the XML message comprises means for transmitting the XML message using the SOAP protocol.

12. The system of claim 9, wherein the processor is configured to execute the application program, wherein the application program sets parameters associated with the request for the image to be acquired.

13. The system of claim 9, wherein the means for acquiring the image includes means for scanning the image.

14. The system of claim 9, wherein the means for transmitting the XML message comprises means for transmitting the XML message from the computing device to the image processing apparatus over the computer network using secure HTTP.

15. A computer-readable medium having encoded therein a program, which when executed by a processor of a computing device, causes the processor to execute a method of acquiring an image from an image processing apparatus, the method comprising the steps of:
executing an application program by the computing device;
indicating, using the application program, that an image is to be acquired using the application program;
transmitting an XML message from the computing device to a web service application executing on the image processing apparatus over a computer network using HTTP, the XML message indicating that the image is to be acquired, wherein the XML message is translated into at least one command compatible with a scanning application of the image processing apparatus by the web service application and the image is acquired by the scanning application of the image processing apparatus using the at least one command;
receiving the image over the computer network from the image processing apparatus; and
storing the image on a storage medium of the computing device.
